(19) United States
(12) Patent Application Publication
(10) Pub. No.: US 2010/0120600 A1
(43) Pub. Date: May 13, 2010

(54) VIBRATING CENTRIFUGE

(75) Inventors: Nicholas Robert Frohlich, JR., Lebanon, OH (US); Bernward Feldkamp, Wesel (DE); Neville Cockcroft, Witbank (ZA)

Correspondence Address: NIXON & VANDERHYE, PC, 901 NORTH GLEBE ROAD, 11TH FLOOR, ARLINGTON, VA, 22203, US

(73) Assignee: ANDRITZ SEPARATION INC., Arlington, TX (US)

(21) Appl. No.: 12/573,325

(22) Filed: Oct. 5, 2009

Related U.S. Application Data
(60) Provisional application No. 61/112,980, filed on Nov. 10, 2008.

(51) Int. Cl. B04B 3/06; B04B 9/00

(52) U.S. Cl. 494/46; 494/47

(57) ABSTRACT

A vibrating centrifuge includes a housing; a basket rotatably supported by the housing; a main drive motor operatively connected to the basket to rotate the basket; a vibration transfer shaft operatively connected to the basket at a first end of the vibration transfer shaft to vibrate the basket; and at least one vibration motor resiliently connected to the housing and operatively connected to the vibration transfer shaft at a second end of the vibration transfer shaft. A vibration drive for a centrifuge including a basket rotatably supported in a housing includes a vibration transfer shaft operatively connected to the basket at a first end of the vibration transfer shaft; and at least one vibration motor connected to a mount, the mount being resiliently connectable to the housing, the vibration transfer shaft being connected to the mount at a second end of the vibration transfer shaft.

### CROSS REFERENCE TO RELATED APPLICATION

This application claims priority to U.S. Application 61/112,980 filed Nov. 10, 2008, the entire contents of which are incorporated herein by reference.

### FIELD OF THE INVENTION

The present invention relates to a vibrating centrifuge, in particular to a drive mechanism for a vibrating centrifuge.

### BACKGROUND OF THE INVENTION

Vibrating centrifuges use radial g force to separate solids and liquids on a screen basket. Materials that are processed by vibrating centrifuges include, for example, coal, salt, potash, with a particle size normally between, for example, 0.5 mm to 75 mm.

Vibrating centrifuges use axial vibration to help convey solids axially along the basket. The g force developed in the machine is typically low, less than 60 g's. Feed is introduced to the small diameter of a rotating screen basket. As the feed accelerates with the basket, it tends to lock to the screen. Axial vibration is added to the basket by rotating eccentric weights attached to the basket drive shaft or to a separate vibration transfer shaft, or by an eccentric shaft attached to a vibration transfer shaft, or by vibratory motors attached to the machine case or the housing vibrating the machine case and/or the housing and the rotating element. The vibration causes the solids retained on the screen to hop from the small to the large diameter of the basket and eventually off the end.

Some prior vibrating centrifuges include complicated eccentric weight mechanisms that are either belt driven or directly driven by a motor connected to an eccentric shaft. These arrangements result in high production costs, increased maintenance requirements, and difficulty in adapting the vibrating centrifuge to process changes.

Some prior art vibrating centrifuges include two large vibrating motors mounted to the sides of the centrifuge housing to vibrate the entire housing the rotating shaft and the basket. This increases the cost of the housing and may result in frequent cracks in the housing. The vibrating motors are also large and expensive. As the vibrating motors must drive the rotating shaft and basket, including any slurry contained in the basket, and must also drive the housing, power consumption is increased.

### BRIEF DESCRIPTION OF THE INVENTION

According to a sample embodiment, a vibrating centrifuge comprises a housing; a basket rotatably supported by the housing; a main drive motor operatively connected to the basket to rotate the basket; a vibration transfer shaft operatively connected to the basket at a first end of the vibration transfer shaft to vibrate the basket; and a vibration motor resiliently connected to the housing and operatively connected to the vibration transfer shaft at a second end of the vibration transfer shaft.

According to another sample embodiment of the invention, a vibration drive for a centrifuge including a basket rotatably supported in a housing comprises a vibration transfer shaft operatively connected to the basket at a first end of the vibration transfer shaft; and a vibration motor connected to a mount, the mount being resiliently connectable to the housing, and the vibration transfer shaft being connected to the mount at a second end of the vibration transfer shaft.

### BRIEF DESCRIPTION OF THE DRAWINGS

FIG. 1 schematically illustrates a vibrating centrifuge according to a sample embodiment;

FIG. 2 schematically illustrates a vibrating centrifuge according to a sample embodiment;

FIG. 3 schematically illustrates a cross-section of the vibrating centrifuge of FIG. 2; and

FIG. 4 schematically illustrates a vibrating centrifuge according to another sample embodiment.

### DETAILED DESCRIPTION OF THE INVENTION

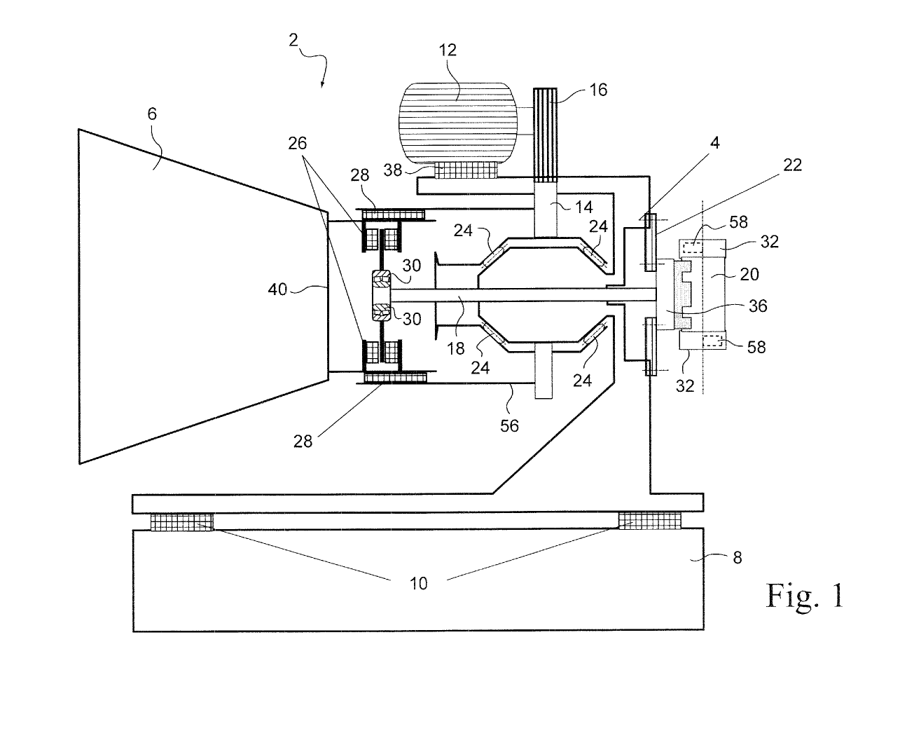

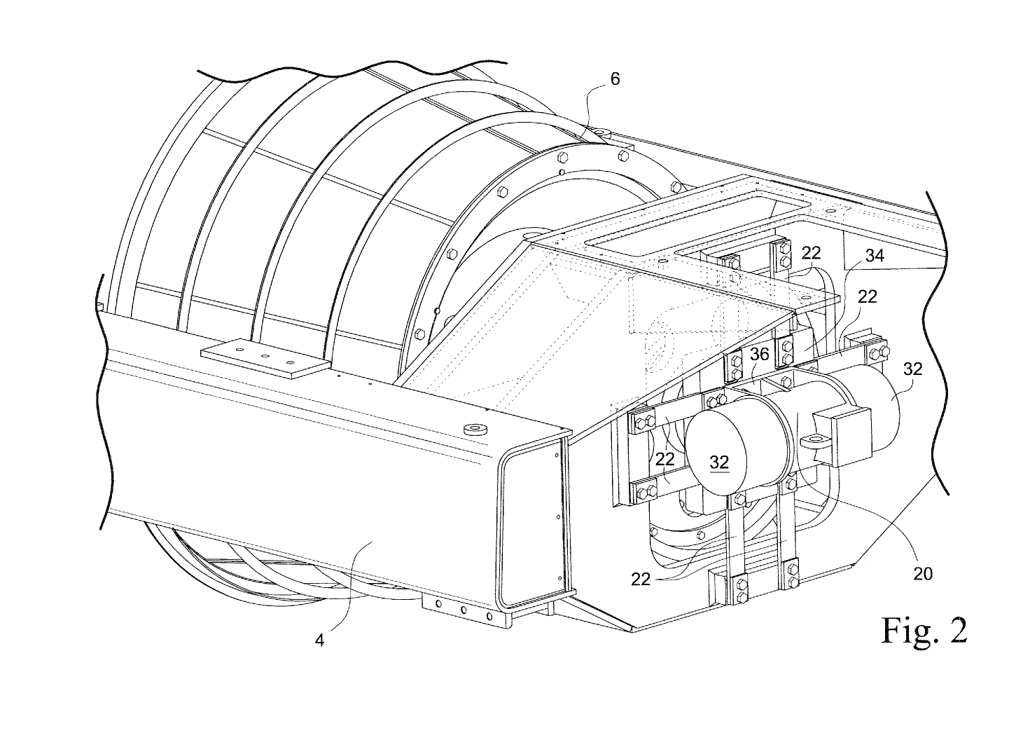

Referring to FIGS. 1-3, a vibrating centrifuge 2 comprises a housing, or frame, 4 and a basket 6. The housing 4 is supported on a base 8, for example, a floor or sub-frame, by vibration dampeners, or buffers, 10.

A main drive motor 12 is configured to rotate the basket 6 through an endless belt 16 which is connected to a pulley 14. The main drive motor 12 may be connected to the housing 4 by a vibration dampener, or buffer, 38.

A vibration motor 20 is connected to a vibration motor mount 36 that is mounted to a vibration shaft mount 34. The vibration shaft mount 34 is connected to the housing by a plurality of springs 22, for example, leaf springs.

A vibration transfer shaft 18 is connected to the vibration shaft mount 34 at a first end and is supported by bearings 30 at a second end. The second end of the vibration transfer shaft 18 is supported by the bearings 30 and is connected to a resonance buffer 26. A main buffer 28 is provided between the rotating basket 6 and the resonance buffer 26. The main buffer 28 is operatively connected to the pulley 14 which is supported in the housing 4 by a plurality of main bearings 24.

The vibration motor 20 comprises two eccentrically mounted weights 58 that are provided in housings 32 at opposite ends of the vibration motor 20. Rotation of the shaft of the vibration motor 20 causes rotation of the eccentrically mounted weights 58 which causes vibration of the vibration motor 20 which is transferred to the vibration shaft mount 34 which is resiliently connected to the housing 4 by the springs 22. The vibration of the motor 20 is thus transferred to the vibration shaft mount 34 which is transferred to the vibration transfer shaft 18. The vibration of the vibration transfer shaft 18 is transferred to the rotating basket 6 through the resonance buffer 26.

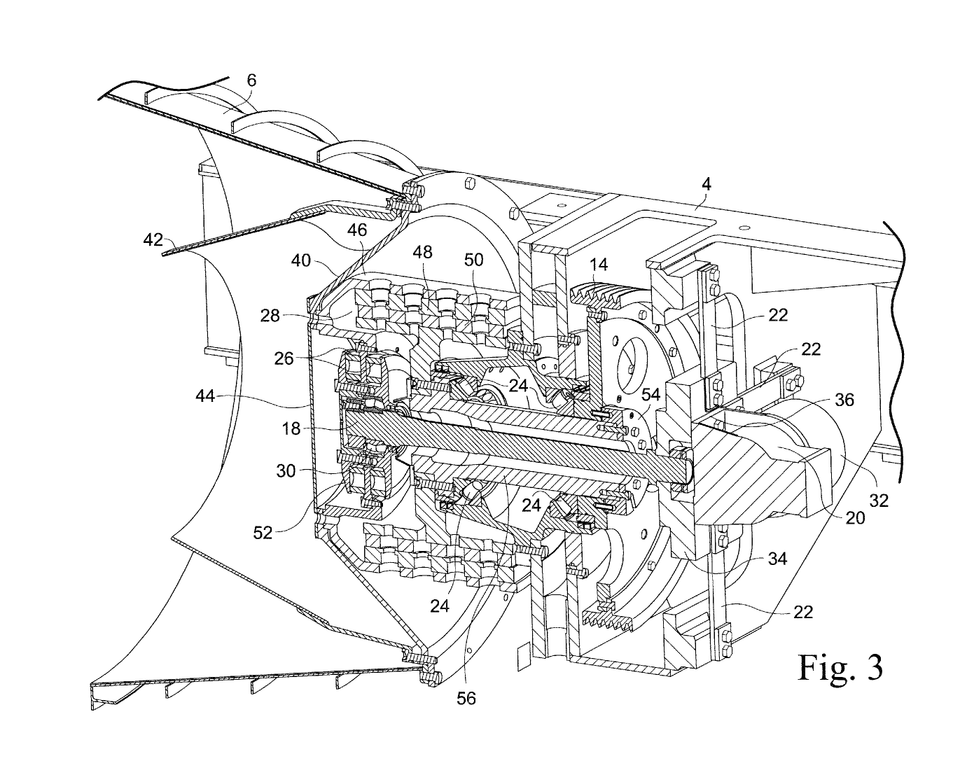

Referring to FIG. 3, the rotating basket 6 includes a back plate 40 that is connected to the main buffer 28. The main buffer 28 includes a main buffer outer drum 46 and a main buffer inner drum 48. A main buffer elastomer material 50 is provided inside the main buffer inner drum 48.

The vibration transfer shaft 18 is connected to the resonance buffer 26 and the resonance buffer 26 is supported in a resonance buffer drum 52 which is connected to the main buffer outer drum 46. A cover plate 44 covers the resonance buffer 26 and separates the resonance buffer 26 from an acceleration cone 42 which receives material to be processed from an inlet chute (not shown).

The main buffer inner drum 48 is connected to a rotation shaft 56 that is connected to the pulley 14 by a rotation shaft mount 54. Rotation of the pulley 14 through the endless belt 16 from operation of the main drive motor 12 is transferred through the rotation shaft 56 to the main buffer inner drum 48 and subsequently to the main buffer outer drum 46 which is connected to the back plate 40 of the basket 6. The main buffer 28 dampens vibrations transmitted to the rotating basket 6 by the vibration transfer shaft 18 from being transmitted to the housing 4.

The connection of the vibration transfer shaft 18 to the rotating basket 6 reduces fabrication and maintenance costs. The connection of the vibration transfer shaft 18 to the rotating basket 6 also improves process adaptability. The vibration motor 20 is easily accessible and replaceable and allows the vibrating centrifuge 2 to be standardized and easily adjusted or replaced to facilitate process changes. The vibration motor 20 drives only the “live load” in the rotating basket 6 and therefore the size of the vibration motor 20 may be smaller than prior art arrangements. In addition, no vibration stress is added to the housing, or frame, 4 and the housing 4 may be reduced in size. As the housing 4 is not vibrated by the vibration motor 20 and because the main buffer 28 dampens vibrations transmitted to the housing 4, housing failures and cracking are reduced.

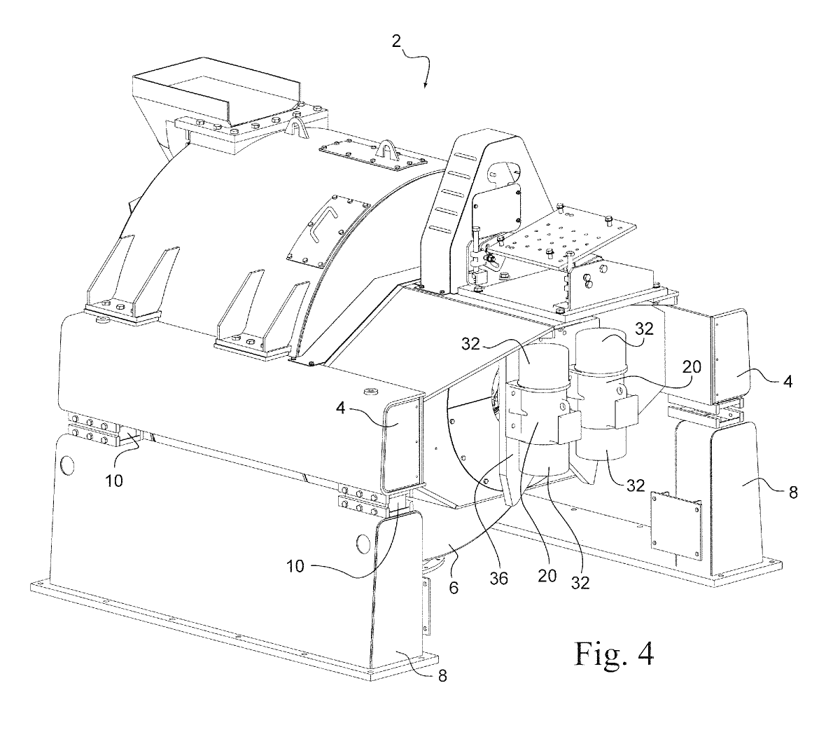

Referring to FIG. 4, a vibrating centrifuge 2 according to another sample embodiment comprises a housing, or frame, 4 and a basket 6. The housing 4 is supported on a base 8, for example, a floor or sub-frame, by vibration dampeners, or buffers, 10. Two vibration motors 20 are connected to a vibration motor mount 36 that is mounted to a vibration shaft mount in a manner similar to that disclosed above with respect to FIGS. 1-3. Each vibration motor 20 comprises two eccentrically mounted weights that are provided in housings 32 at opposite ends of the vibration motor 20. Rotation of the shafts of the vibration motors 20 causes rotation of the eccentrically mounted weights which causes vibration of the vibration motors 20 which is transferred to the vibration shaft mount which is resiliently connected to the housing 4 by springs in a manner similar to that described above with respect to FIGS. 1-3. The vibration of the motors 20 is thus transferred to the vibration shaft mount which is transferred to the vibration transfer shaft. The vibration of the vibration transfer shaft is transferred to the rotating basket 6 through a resonance buffer as described above.

As shown in FIG. 4, the vibration motors 20 are mounted to the vibration motor mount 36 vertically, i.e. the shafts of the vibration motors are oriented vertically. It should be appreciated that the vibration motors 20 may be mounted to the vibration motor mount horizontally. The vertical orientation of the vibration motors 20 facilitates achieving a counter synchronic rotation direction of the unbalanced weights, thus providing an alternating resulting force in one direction for product conveyance on the basket deck.

Although two vibration motors are shown in FIG. 4, it should be appreciated that more than two motors may be provided.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A vibrating centrifuge, comprising:
a housing;
a basket rotatably supported in the housing;
a main drive motor operatively connected to the basket to rotate the basket;
a vibration transfer shaft operatively connected to the basket at a first end of the vibration transfer shaft to vibrate the basket; and
at least one vibration motor resiliently connected to the housing and operatively connected to the vibration transfer shaft at a second end of the vibration transfer shaft.

2. A vibrating centrifuge according to claim 1, wherein the first end of the vibration transfer shaft is connected to the basket by a buffer.

3. A vibrating centrifuge according to claim 2, further comprising a bearing between the buffer and the first end of the vibration transfer shaft.

4. A vibrating centrifuge according to claim 1, wherein the vibration transfer shaft and the at least one vibration motor are connected to a mount that is resiliently connected to the housing.

5. A vibrating centrifuge according to claim 4, wherein the mount is resiliently connected to the housing by at least one spring or other resilient material.

6. A vibrating centrifuge according to claim 5, wherein the at least one spring is a leaf spring.

7. A vibrating centrifuge according to claim 1, wherein the at least one vibration motor comprises at least one eccentric weight.

8. A vibrating centrifuge according to claim 1, wherein the main drive motor is connected to the housing by a vibration dampener.

9. A vibrating centrifuge according to claim 1, wherein the housing is connected to a base by at least one vibration dampener.

10. A vibrating centrifuge according to claim 1, wherein the main drive motor is connected to the basket by a rotation shaft.

11. A vibrating centrifuge according to claim 10, further comprising a buffer operatively connected between the rotation shaft and the basket.

12. A vibrating centrifuge according to claim 11, wherein the buffer comprises an outer drum connected to the basket, an inner drum connected to the rotation shaft, and an elastomer material between the outer drum and the inner drum.

13. A vibrating centrifuge according to claim 10, further comprising a pulley operatively connected to the main drive motor to rotate the rotation shaft.

14. A vibrating centrifuge according to claim 13, wherein the pulley is operatively connected to the main drive motor by an endless belt.

15. A vibrating centrifuge according to claim 10, wherein the rotation shaft is coaxial with the vibration transfer shaft.

16. A vibrating centrifuge according to claim 13, wherein the pulley is coaxial with the vibration transfer shaft.

17. A vibrating centrifuge according to claim 11, wherein the buffer is connected to a second buffer that is connected to the second end of the vibration transfer shaft.

18. A vibrating centrifuge according to claim 1, wherein the at least one vibration motor comprises two vibration motors.

19. A vibrating centrifuge according to claim 18, wherein the two vibration motors are oriented vertically.

20. A vibration drive for a centrifuge including a basket rotatably supported in a housing, the vibration drive comprising:
a vibration transfer shaft operatively connected to the basket at a first end of the vibration transfer shaft; and
at least one vibration motor connected to a mount, the mount being resiliently connectable to the housing, the vibration transfer shaft being connected to the mount at a second end of the vibration transfer shaft.

21. A vibration drive according to claim 20, wherein the at least one vibration motor comprises at least one eccentric weight.

22. A vibration drive according to claim 20, wherein the mount is resiliently connectable to the housing by at least one spring or other resilient material.

23. A vibration drive according to claim 22, wherein the at least one spring comprise a leaf spring.

24. A vibration drive according to claim 20, further comprising a buffer connected to the second end of the vibration shaft.

25. A vibration drive according to claim 24, further comprising a bearing between the buffer and the second end of the vibration transfer shaft.

26. A vibration drive according to claim 24, wherein the buffer comprises a drum and an elastomer material within the drum.
